(19) United States
(12) Patent Application Publication
(10) Pub. No.: US 2007/0022391 A1
(43) Pub. Date: Jan. 25, 2007

(54) Method and apparatus for changing a shape of a mouse cursor corresponding to an item on which the mouse cursor is located

(75) Inventors: Duk-yong Kim, Suwon-si (KR); Hee-ran Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/486,077

(22) Filed: Jul. 14, 2006

(30) Foreign Application Priority Data
Jul. 19, 2005 (KR) 2005-65512

(51) Int. Cl. G06F 3/00

(52) U.S. Cl. 715/856; 715/861; 715/862; 715/859

(57) ABSTRACT

A method and apparatus to change a mouse cursor corresponding to an item on which mouse cursor is located, with the method to change the mouse cursor including: locating the mouse cursor on the predetermined printing option item on the User Interface (UI) corresponding to a printing option setting; and changing the shape of the mouse cursor into the image corresponding to the function of the printing option item on which the mouse cursor is located. Accordingly, a user can more easily understand corresponding functions through the shapes of the mouse cursor changed into the image corresponding to the function on which the mouse cursor is located at the time.

### CROSS-REFERENCE TO RELATED APPLICATIONS

This application claims the benefit of Korean Application No. 2005-65512, filed Jul. 19, 2005, in the Korean Intellectual Property Office, the disclosure of which is incorporated herein by reference.

### BACKGROUND OF THE INVENTION

1. Field of the Invention

Aspects of the invention relate to a method and apparatus to change a mouse cursor corresponding to an item on which mouse cursor is located.

2. Description of the Related Art

Generally, a printing control apparatus requires a printer driver provided from the printing apparatus manufacturer, to control a printing apparatus to print, when documents made on an application program of a printing control apparatus, such as a computer, are printed through printing apparatuses, such as a printer and a multifunctional apparatus.

The printer driver provides a UI (User Interface) setting printing options to apply to documents to be printed. A user can set printing options with respect to various options items (for example, printing range, paper types, printing directions, resolutions, overlay, watermark, collation, and duplex printing)

However, with various and upgraded functions of the printing apparatuses, it can be difficult to know each printing option function provided by a printing option apparatus. Accordingly, the printer driver helps the user to understand the function of the corresponding printing option by displaying on a predetermined area of the UI a preview image which shows documents to be printed having the user selected printing option applied, in advance of printing.

FIG. 1 is an example of UI for setting printing options provided from a conventional printer driver. Referring to FIG. 1, where the selected option item is a printing option item 11 which corresponds to a ‘duplexed printing’ function based on a long edge at the UI 10, the conventional printer driver, as illustrated in FIG. 1, displays on the preview area 12 of the UI 10 a preview image for showing that documents will be successively printed on a front and a rear side of printing paper.

The preview image provided from the UI of the conventional printer driver is static and, therefore, a user can have difficulty in immediately understanding the meaning of the corresponding images. Thus, the user can also have difficulty to intuitively, at a glance, understand that the preview image of FIG. 1 is duplexed-printed based on a long edge. In this regard, a predetermined area of the UI is be allocated to show the preview image, which can limit the number of printing option items to be arranged on the UI.

### SUMMARY OF THE INVENTION

An aspect of the invention is to address the above and/or other problems and/or disadvantages of the related art and to provide other advantages, such as below described. Accordingly, aspects of the invention are, among other aspects of the invention, to provide a method and apparatus to change a shape of a mouse cursor into an image corresponding to a function of an item on which the mouse cursor is located when the mouse cursor is on the predetermined item on a UI (User Interface).

In order to achieve the above-described and/or other aspects of the invention, there is provided an apparatus and a method to change a shape of a mouse cursor corresponding to an item on which mouse cursor is located, including: locating the mouse cursor on a predetermined item, such as a printing option item, on the UI corresponding to a printing option setting; and changing a shape of the mouse cursor into the image corresponding to the function of the item, such as the printing option item, on which mouse cursor is located.

The changing of the shape of the mouse cursor includes: requesting to change the shape of the mouse cursor into the image corresponding to the function of the item, such as the printing option item, on which mouse cursor is located; and changing the shape of the mouse cursor into the image requested and indicating the change of the shape of the mouse cursor. The image can be one out of an animation image, a moving image and a static image to explain the functions of the corresponding items, such as the printing option items.

According to further aspects of the invention, when a command is received to change the mouse cursor size, the changing of the shape of the mouse cursor includes changing the mouse cursor size according to the received command. Also, where the mouse cursor is positioned away from the item, such as the printing option item, or where a command is received to remove the current image shape of the mouse cursor, the changing of the shape of the mouse cursor includes an operation of further changing the current image shape of mouse cursor into a prior image shape of the mouse cursor.

In order to achieve the above-described and/or other aspects of the invention, there is provided a printing control apparatus, including: a print driver unit to provide a UI to print an option setting and to change a shape of a mouse cursor into an image corresponding to a function of the printing option item on which mouse cursor is located, where the mouse cursor is on a predetermined item on the UI; and a control unit to provide location information of the mouse cursor to the print driver unit and to display the mouse cursor on the display unit as the image changed in shape to correspond to the function of the printing option item by the print driver unit.

The print driver unit includes a UI part to provide the UI, an image storing part to store at least one image corresponding to a function of at least one printing option item, and a requesting part to request a change of a cursor shape into an image having a shape corresponding to a function of the printing option item stored at the image storing part, where the mouse cursor is located on a predetermined printing option item on the UI.

According to aspects of the invention, where a command is received to change the mouse cursor size, the control unit changes the mouse cursor size according to the received command and displays the mouse cursor corresponding to the changed size on the display unit. Also, where the mouse cursor is positioned away from the item, such as the printing option item, or where a command is received to remove the current image shape of the mouse cursor, the control unit further changes the current image shape of the mouse cursor into a prior image shape of the mouse cursor and displays the prior image shape of the mouse cursor on the display unit.

Additionally, in order to achieve the above-described and/or other aspects of the invention, there is provided a method of changing a shape of a mouse cursor, including: locating a mouse cursor on a predetermined item on a UI provided from a predetermined application program and changing the shape of the mouse cursor into the image corresponding to a function of the item on which the mouse cursor is located.

Also, in order to achieve the above-described and/or other aspects of the invention, there is provided a computer, including: an application programming part to provide a predetermined UI and to change a shape of the mouse cursor into the image corresponding to a function of an item of the UI, where the mouse cursor is located on a predetermined item of the UI; and a control unit to provide location information on the mouse cursor to the application programming part and to display the mouse cursor on a display unit as an image of a changed shape corresponding to the predetermined item of the UI as changed by the application programming part.

Further, in order to achieve the above-described and/or other aspects of the invention, there is provided a method of changing a shape of a mouse cursor, including: changing a size of the mouse cursor according to a received command, where the command is received to change the size of the mouse cursor; locating the size changed mouse cursor at a predetermined item of a UI, such as a printing option item on a UI corresponding to a printing option setting; and changing the shape of the mouse cursor into an image having a changed size of the mouse cursor and of a shape corresponding to the function of the item, such as a printing option item.

Additionally, in order to achieve the above-described and/or other aspects of the invention, there is provided a method of changing a shape of a mouse cursor including: changing a mouse cursor size according to a received command, where a command to change the mouse cursor is received; locating the mouse cursor with the changed size on a predetermined item on a UI provided from a predetermined application program; and changing the shape of the mouse cursor into a shape of an image corresponding to a function of the item on which the mouse cursor is located, with the mouse cursor being of the changed size.

Further, in order to achieve the above-described and/or other aspects of the invention, there is provided a method of changing a shape of a mouse cursor including: receiving a command to change a size of a mouse cursor; and changing the size of the mouse cursor according to the received command.

Additional aspects and/or advantages of the invention are set forth in or are evident from the description which follows, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an example of a User Interface (UI) to set printing options provided from a conventional printer driver,

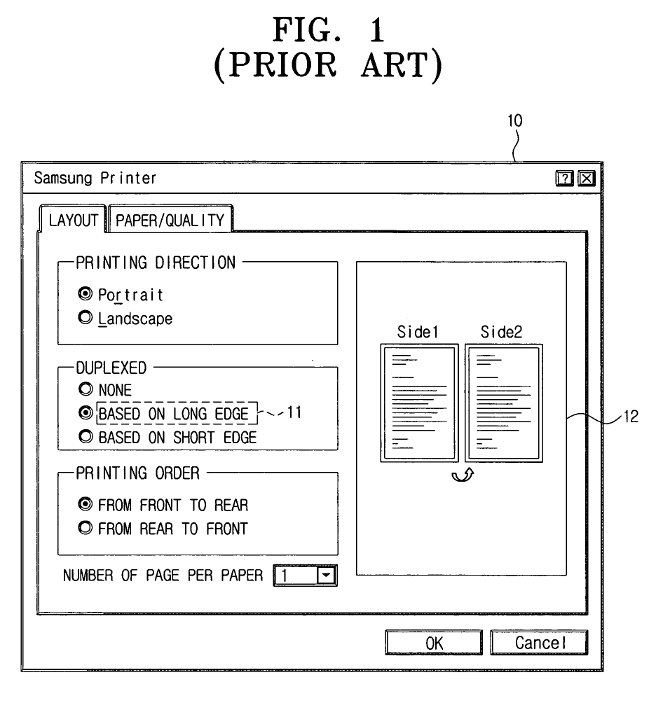

FIG. 2 is a block diagram of a printing control apparatus according to an embodiment of the invention,

FIG. 3 is an illustration to explain an example of a mouse cursor changing into an animation image, where the mouse cursor is located on a predetermined item, such as a printing option item, on a UI according to an embodiment of the invention,

FIG. 4 is an illustration to explain an example of a mouse cursor changing into an animation image, where a mouse cursor is located on a predetermined item, such as a printing option item, on a UI according to an embodiment of the invention,

FIG. 5 is an illustration to explain a pop up menu to receive commands to change a mouse cursor into an animation image where a mouse cursor is located on a predetermined item, such as a printing option item, on a UI and to remove a current image shape of a mouse cursor according to an embodiment of the invention,

FIG. 6 is a flowchart to change a shape of the mouse cursor into an image corresponding to a function of the item, such as a printing option item, on a UI according to an embodiment of the invention,

FIG. 7 is a flowchart of a method of changing a shape of a mouse cursor according to an embodiment of the invention, and

FIG. 8 is a flowchart of the method of changing a shape of a mouse cursor according to an embodiment of the invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain the invention by referring to the figures.

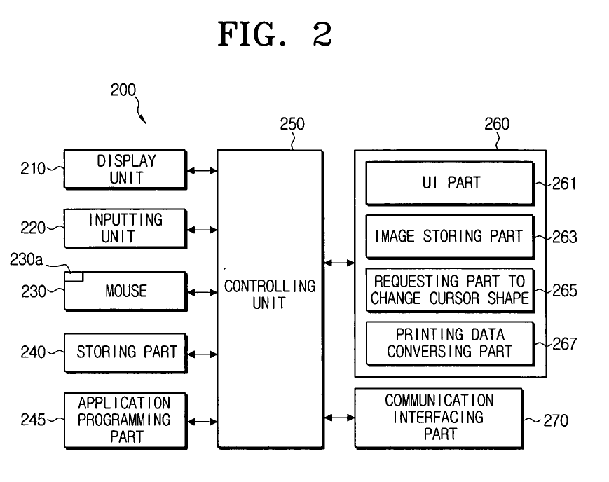

FIG. 2 is a block diagram of a printing control apparatus 200, such as a computer, according to an embodiment of the invention. Referring to FIG. 2, the printing control apparatus 200, according to an aspect of the invention includes a display unit 210, an inputting part 220, a mouse 230, a storing part 240, an application programming part 245, a control unit 250, a print driver unit 260, and a communication interfacing part 270.

The print driver unit 260 comprises a User Interface (UI) interfacing part (hereinafter, referred to as ‘UI part’) 261, an image storing part 263, a requesting part to request a change a cursor shape 265, and a printing data conversing part 267.

The display unit 210 displays various types of information offered by a printing control apparatus 200 under control of the control unit 250, and can be a monitor embodied with a CRT (Cathode Ray Tube) or a LCD (Liquid Crystal Display), or other suitable display device.

The inputting part 220 can be an inputting apparatus, such as a keyboard having a plurality of keys, or other suitable inputting apparatus, enabling a user to set or select various functions supported by the printing control apparatus 200. According to an embodiment of the invention, the inputting part 220 includes the inputting apparatus excluding the mouse 230, but aspects of the invention are not limited in this regard, and the inputting apparatus can be integrated with the mouse 230, for example.

The mouse 230, such as any suitable mouse, transmits to the control unit 250 corresponding signals, such as whenever the mouse moves a distance in an X direction and/or Y direction by a user or the user activates a mouse button 230a.

The storing part 240 stores various programs and/or software and data needed to embody functions of the printing control apparatus 200, and stores documents to print which are made by the application programming part 245. The storing part 240 can include a suitable memory, such as a read only memory (ROM), a random access memory (RAM), and can also include floppy disks, hard disks, optical recording media (e.g., CD-ROMs, DVDs, etc.), and/or suitable storage media.

The application programming part 245 performs a document work to be printed and receives a command to print the completed document to be printed. The application programming part 245 can include a word process program, a database program, an image editing program, or other suitable programming or software.

Also, the application programming part 245 can provide a UI and change the shape of the mouse cursor into the image corresponding to a function of an item of the UI, where the mouse cursor is located on a predetermined item of the UI; and the control unit 250 provides location information on the mouse cursor to the application programming part 245 to display the mouse cursor on a display unit as an image of a changed shape corresponding to the predetermined item of the UI as changed by the application programming part 245. Further, the item(s) on the UI, to which aspects of the invention apply, are not limited to printing option items, such as in relation to the printing control apparatus 200, and can apply to other items of the UI in the printing control apparatus 200 or in other devices having a UI, such as a computer.

The communication interfacing part 270 provides an interface wherein the printing control apparatus 200 can be connected to an external device, and can include a parallel port, USB port and a wireless module, or other suitable interface. The communication interfacing part 270, connected to a printing apparatus, such as a printer, transmits printing data converted at the print driver unit 260 to the printing apparatus, to be printed.

The print driver unit 260 converts the document to be printed, where a command for printing from the application programming part 245 is received, into printing data interpretable at the printing apparatus. The print driver unit 260 requests the control unit 250 to change the mouse cursor into an image displaying a function corresponding to the printing option item on which the mouse cursor is located, when the mouse cursor is located on one of the printing option items included in the UI.

When the mouse cursor is located on the printing option item and a button of the mouse 230 is clicked, the printing driving part 260 applies the printing option function corresponding to each printing option item at the document to be printed and converts into the printing data. Generally, the printing option item can be a control, such as a button or a check box and embodied at the UI.

More particularly, the print driver unit 260 according to an embodiment of the present invention includes a UI part 261, an image storing part 263, a requesting part to request a change a cursor shape 265, and a printing data conversing part 267. When a command is received to set an option, such as the printing option, the UI part 261 displays the UI including a plurality of items, such as the printing option items, on the display unit 210 and has the option item, such as the printing option set by the user. In this regard, where the item is a printing option item, the printing data conversing part 267 converts the document to be printed into the printing data interpretable at the printing apparatus by applying the printing option values set by the user corresponding to the printing option according to reference values.

The image storing part 263 stores an image corresponding to the function, such as the printing option function, of each item, such as each printing option item, included in the UI. The image can be an animation image, a moving image or a static image, such as designed to assist the user to understand printing effects arising from applying the printing option function of the printing option item on which the mouse cursor is located at the documents to be printed. The requesting part 265 requests a change of the cursor shape and transmits to the control unit 250 a message requesting to change the shape of the mouse cursor into the image displaying the item, such as the printing option function of the printing option item on which the mouse cursor is located, out of images stored at the image strong part 263, where the mouse cursor is located on a predetermined printing option item on the UI.

The control unit 250 controls overall operations of the printing control apparatus 200, and supervises and controls each component of the printing control apparatus 200 and program to properly operate. For example, the control unit 250 can be a Windows operation system program such as Windows 98, Windows NT, or Windows XP, or other suitable operating system program. Also, the control unit 250 can be any suitable processing device, such as a processor, microprocessor or an application specific integrated circuit (ASIC), with associated memory and software or programming, to control the operations of the printing control apparatus 200. Where a command for setting an option, such as the printing option, is received through the inputting part 220 or the mouse 230, the control unit 250 drives the print driver unit 260 and displays the UI for setting the option, such as the printing option, on the display unit 210.

The control unit 250 displays the mouse cursor on the position of the display unit 210 corresponding to location information of the mouse cursor determined on the basis of a transmitted signal from the mouse 230. The control unit 250 provides a message including the determined location information of the mouse cursor, to the print driver unit 260 and the application programming part 245. Where a request for changing the shape of the mouse cursor is received from the print driver unit 260, the control unit 250 changes the shape of the mouse cursor into a requested image and displays the changed image on the display unit 210.

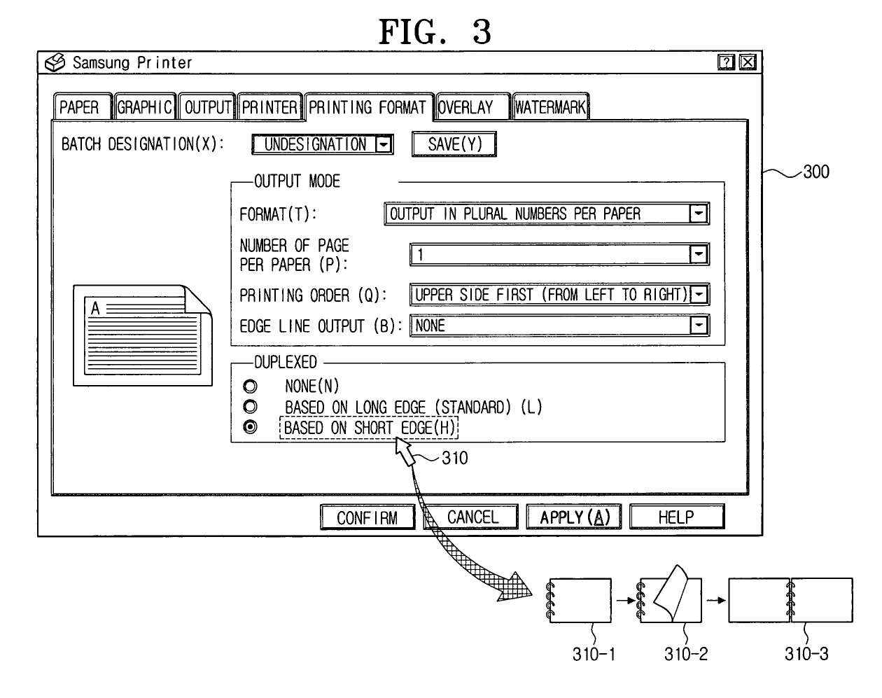

For example, as shown in FIG. 3, where the mouse cursor 310 is on the printing option item corresponding to a duplexed printing function based on a short edge on the UI 300, the mouse cursor shape is changed into the animation image (310-1, 310-2, 310-3) which dynamically shows the mouse cursor 310 turn over one page by one page based on a short edge.

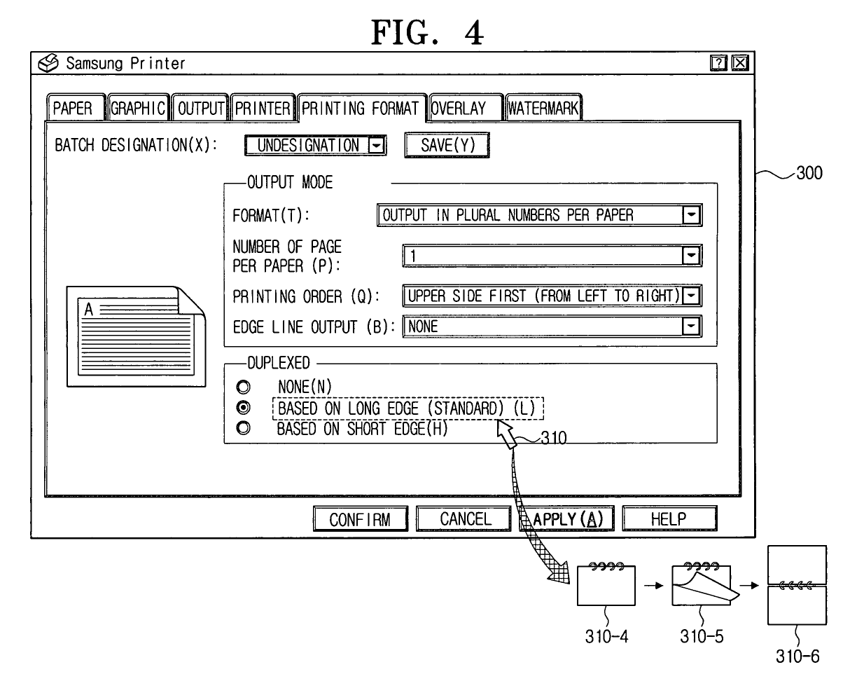

As shown in FIG. 4, where the mouse cursor 310 is located on the printing option item corresponding to the duplexed printing function based on a long edge on the UI 300, the mouse cursor shape is changed into the animation image (310-4, 310-5, 310-6) which dynamically shows the mouse cursor 310 turn over one page by one page based on a long edge.

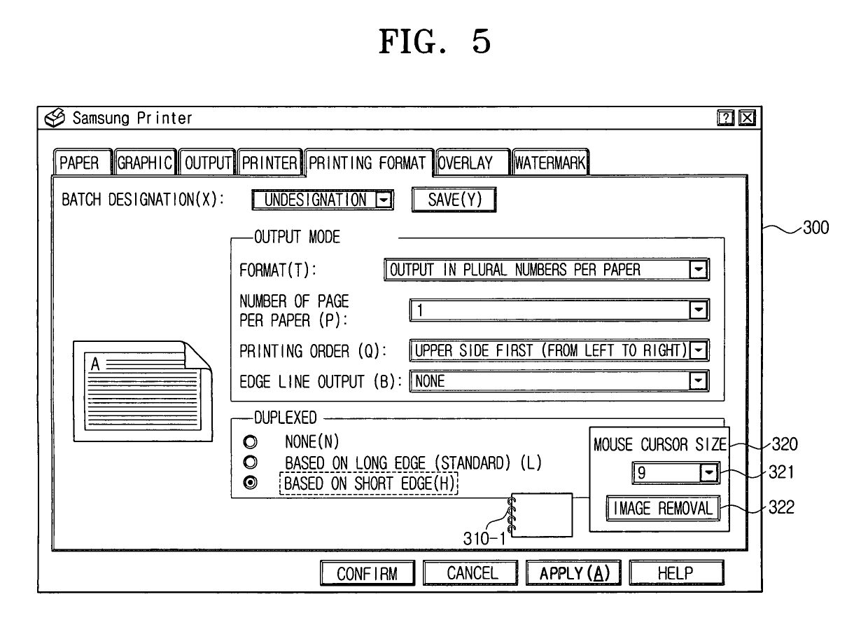

Also, where a button 230a of the mouse 230 is clicked while the mouse cursor is changed into an animation image, the control unit 250, as shown in FIG. 5, displays a pop up menu 320 to receive a command including commands to change the mouse cursor size and remove the image on the display unit 210. The pop up menu 320 includes a button 321 to receive a command to change the mouse cursor size and a button 322 to receive a command to remove the image.

Where the command to change the mouse cursor size on the pop up menu 320 is received, the control unit 250 changes the mouse cursor size according to the received command to change the mouse cursor size, and displays the mouse cursor of the changed size on the display unit 210. Where the mouse cursor, changed into the image corresponding to the item, such as the printing option item, is small and a user can have difficulty in understanding the contents displayed, the user, by use of the command to change the mouse cursor size, can enlarge the mouse cursor size to more easily figure out the function, such as the printing option function.

Further, where the mouse cursor is away from the item, such as the printing option item, or a command to remove an image is received on the pop up menu 320, the control unit 250 changes the current image shape of the mouse cursor into a prior image shape, before the change into the current image shape corresponding to the function of the printing option item, and displays the prior image shape on the display unit 210.

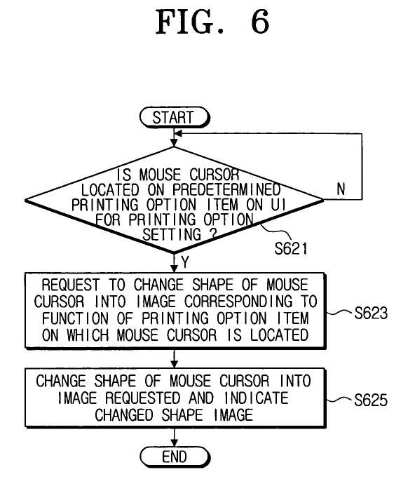

FIG. 6 is a flowchart to illustrate changing a shape of the mouse cursor into an image corresponding to a function of the item, such as a printing option item, on which the mouse cursor is located according to an embodiment of the invention. For example, referring to FIGS. 2 through 6, where the item is a printing option item, the print driver unit 260 displays a UI to set the printing option on the display unit 210, when the command to set the printing option is received. The print driver unit 260 requests the control unit 250 to change the mouse cursor shape into the image corresponding to the function of the printing option item on which the mouse cursor is located at operation S623, where the mouse cursor is judged to be located on one out of the printing option items included in the UI, based on location information of the mouse cursor transmitted from the control unit 250, at operation S621-Y.

The control unit 250 changes the shape of the mouse cursor into the image requested, corresponding to the function of the printing option item on which the mouse cursor is located, received from the print driver unit 260, and the control unit 250 displays the changed image shape on the display unit 210, at operation S625. By changing the shape of the mouse cursor into the image corresponding to the function of the printing option item on which the mouse cursor is located, the user can intuitively understand the function of the printing option item on which the mouse cursor is located, by viewing the shape of the mouse cursor changed into the image corresponding to the function of the printing option item.

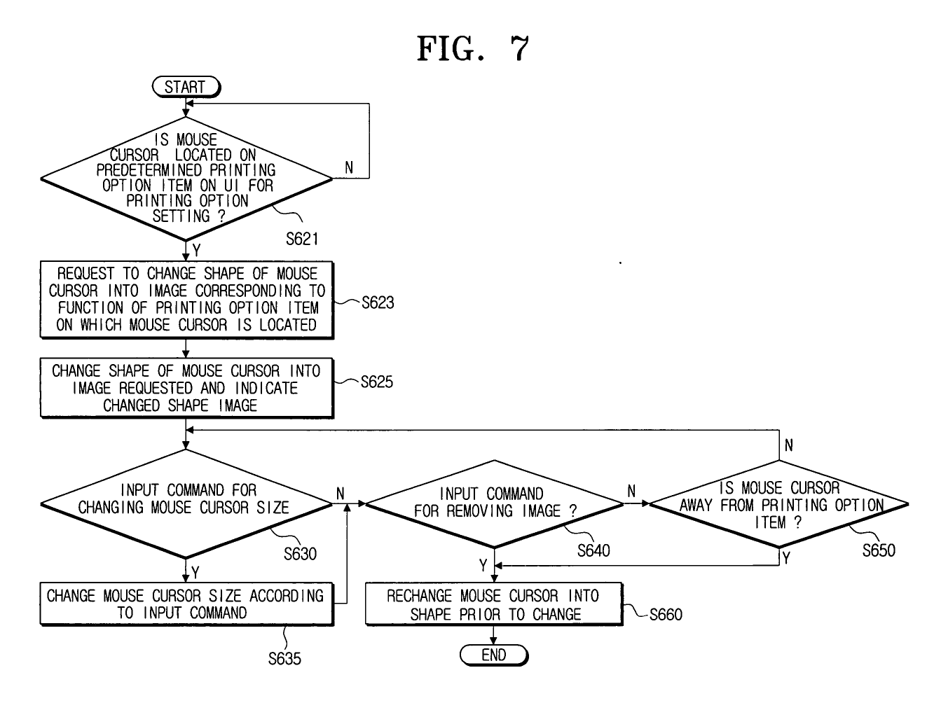

FIG. 7 is a flowchart illustrating operations of changing a shape of a mouse cursor according to a further embodiment of the invention. Referring to FIGS. 2 through 7, the first three operations namely, the operations S621, S623, and S625, of changing the mouse cursor shape into the image corresponding to the printing option item, are the same as previously described in an embodiment of the invention of FIG. 6. Therefore, the shape of the mouse cursor is changed into the shape of the image corresponding to the function of the printing option item on which the mouse cursor is located and displayed on the display unit 210, at operation S625.

Where a command is received from the user to change the size of the mouse cursor at operation S630-Y, the control unit 250 enlarges or reduces the size of the mouse cursor according to the received command at operation S635. Also, the control unit 250 changes the current image shape of the mouse cursor into the prior image shape of the mouse cursor, as before the change into the current image shape corresponding to the function of the printing option item S660, when the command is received from the user to remove the image shape of the mouse cursor at operation S640-Y, or where the mouse cursor is away from the printing option item at operation S650-Y, and where the command to changing the size of the mouse cursor is not received at operation S630-N or the image shape of the mouse cursor is changed at operation S660.

Therefore, according to aspects of the invention, where the user can have difficulty in understanding the displayed contents due to a small sized mouse cursor changed into the image corresponding to the function of the item, such as the printing option item, the user can enlarge the size of the mouse cursor to more easily figure out the function of the item, such as the printing option item. Also, according to aspects of the invention, where the user does not want to use the mouse cursor changed into the image corresponding to the item, such as a printing option item, the user can change the mouse cursor back to the prior image shape provided as a default, such as an arrow corresponding to a function of pointing to a predetermined location.

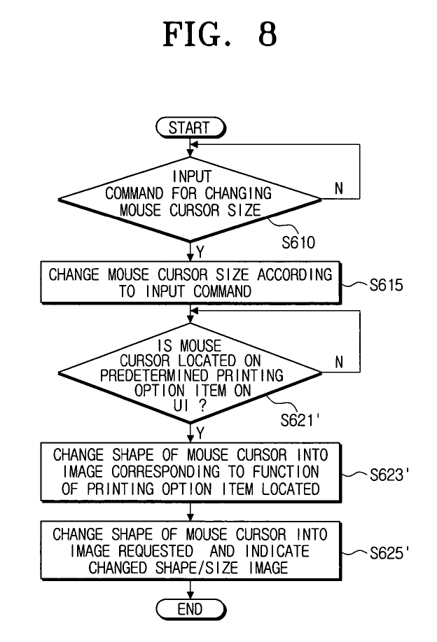

FIG. 8 is a flowchart illustrating operations of changing the shape of the mouse cursor according to another embodiment of the invention. Referring to FIGS. 2 through 8, for example, where the item is a printing option item, FIG. 8 describes an embodiment of changing the size of the mouse cursor before changing the shape of the image corresponding to the function of the printing option item. Where the command to change the size of the mouse cursor is received at operation S610-Y, the control unit 250 enlarges or reduces the size of the mouse cursor according to the received command at operation S615.

Where the mouse cursor having the changed size during operation S615 is located on one of the printing option items included in the UI at operation S621′-Y, the control unit 250, through a received command to change the shape of the mouse cursor or through programming to change the shape of the mouse cursor where located on a printing option item, for example, is requested at operation S623′ to change the shape of the mouse cursor into the image having a shape corresponding to the function of the printing option item on which the mouse cursor is located and having the changed mouse cursor size.

The control unit 250 then changes the shape of the mouse cursor into the image requested having a shape corresponding to the function of the printing option item on which the mouse cursor is located from the print driver unit 260, and displays the changed shape/size image of the mouse cursor on the display unit 210, at operation S625′. Also, it is possible to change the size and the shape of the mouse cursor where the command to change the mouse cursor size is received at operation S630-Y, the command to remove the image at operation S640-Y is received, or where the mouse cursor is away from the printing option item at operation S650-Y after the operation S625 as shown in the embodiment of FIG. 7.

As described, aspects of the invention can provide changing the shape of the mouse cursor into the image corresponding to the function of the item, such as a printing option item, on which the mouse cursor is located when the mouse cursor is located on a particular item, such as a printing option item, on the UI, such as to set the printing option provided from print driver unit 260. However, as is evident from the forgoing description, aspects of the invention can also include, for example, the application programming part 245 requesting the control unit 250 to change the shape of the mouse cursor so that the shape of the mouse cursor is changed into an image that corresponds to or explains the function of the item, other than a printing option item, on which the mouse cursor is located, when the mouse cursor is located on the particular item(s) of the UI, such as provided from at least one of the print driver unit 260 and the application programming part 245.

As above mentioned, according to aspects of the invention, a user can more easily understand corresponding functions through the shapes of the mouse cursor changed into the image corresponding to the function on which the mouse cursor is located at the time. Thus, in order to explain functions of corresponding items, there is typically no need to allocate a certain area of the UI for a preview image, and, accordingly, allowing a more efficient use the UI space is promoted. Also, the user can adjust the mouse cursor into a desired size and display accordingly, thereby promoting improved convenience to the user.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A method of changing a shape of a mouse cursor, comprising:
locating the mouse cursor on a predetermined printing option item on a User Interface (UI) corresponding to a printing option setting; and
changing an image shape of the mouse cursor into an image shape corresponding to a function of the predetermined printing option item on which the mouse cursor is located.

2. The method of changing the shape of the mouse cursor of claim 1, wherein:
the image shape comprises one of an animation image, a moving image and a static image to explain the function of the corresponding printing option item.

3. The method of changing the shape of the mouse cursor of claim 1, wherein the changing the image shape of the mouse cursor comprises:
requesting to change the image shape of the mouse cursor into an image shape corresponding to the function of the predetermined printing option item on which the mouse cursor is located; and
changing, according to the request, the image shape of the mouse cursor into the image shape corresponding to the function of the predetermined printing option item on which the mouse cursor is located and indicating the changed image shape of the mouse cursor.

4. The method of changing the shape of the mouse cursor of claim 1, further comprising:
changing a size of the mouse cursor size according to a received command, where the command is received to change the mouse cursor size.

5. The method of changing the shape of the mouse cursor of claim 1, wherein:
where the mouse cursor is away from the predetermined printing option item, the changing the image shape of the mouse cursor comprises changing the current image shape of the mouse cursor into a prior image shape of the mouse cursor.

6. The method of changing the shape of the mouse cursor of claim 1, wherein the changing the image shape of the mouse cursor further comprises:
changing the image shape of the mouse cursor into a prior image shape from the current image shape, where a command is received to remove the current image shape of the mouse cursor.

7. A method of changing a shape of a mouse cursor, comprising:
locating a mouse cursor on a predetermined item on a User Interface (UI) provided from a predetermined application program; and
changing an image shape of the mouse cursor into an image shape corresponding to a function of the predetermined item on which the mouse cursor is located.

8. The method of changing the shape of the mouse cursor of claim 7, wherein:
the image comprises one of an animation image, a moving image and a static image to explain the corresponding function of the predetermined item.

9. A computer including a display unit and a mouse to move a mouse cursor displayed on the display unit, comprising:
an application programming part to provide a User Interface (UI) and to change an image shape of the mouse cursor into an image shape corresponding to a function of a predetermined item, where the mouse cursor is located on the predetermined item of the User Interface (UI); and
a control unit to provide location information on the mouse cursor to the application programming part and to display the mouse cursor on the display unit as a changed image shape.

10. A method of changing a size of a mouse cursor, comprising:
receiving a command to change a size of a mouse cursor; and
changing the size of the mouse cursor according to the received command.

11. The method of changing the size of the mouse cursor of claim 10, wherein:
the size changed mouse cursor comprises an image shape.

12. The method of changing the size of the mouse cursor of claim 11, wherein:
the image comprises one of an animation image, a moving image and a static image to explain a corresponding function of an item of a User Interface (UI).

13. The method of changing the size of a mouse cursor of claim 10, further comprising:
changing an image shape of the mouse cursor into an image shape corresponding to a function of an item of a User Interface (UI) on which the mouse cursor is located.

14. A method of changing a shape of a mouse cursor, comprising:
changing an image shape of the mouse cursor into an image shape corresponding to a function of an item of a User Interface (UI) on which the mouse cursor is located.

15. The method of changing the shape of the mouse cursor of claim 14, wherein:
the image comprises one of an animation image, a moving image and a static image to explain the corresponding function of the item on which the mouse cursor is located on the User Interface (UI).

16. The computer of claim 9, further comprising:
an image storing part to store at least one image shape corresponding to a function of at least one predetermined item of the User Interface (UI); and
a requesting part to request a change of the image shape of the mouse cursor into the image shape corresponding to the function of the predetermined item stored at the image storing part, where the mouse cursor is located on the predetermined item on the User Interface (UI).

17. The computer of claim 16, wherein:
the image comprises one of an animation image, a moving image and a static image to explain the corresponding function of the predetermined item on which the mouse cursor is located on the User Interface (UI).

18. The computer of claim 9, wherein:
where a command is received to change a size of the mouse cursor, the control unit changes the size of the mouse cursor according to the received command and displays the mouse cursor of the changed size on the display unit.

19. The computer of claim 9, wherein:
where the mouse cursor is away from the predetermined item of the User Interface (UI), the control unit changes the current image shape of the mouse cursor into a prior image shape and displays the prior image shape of the mouse cursor on the display unit.

20. The computer of claim 9, wherein:
where a command is received to remove the image shape, the control unit changes the current image shape of the mouse cursor into a prior image shape and displays the prior image shape of the mouse cursor on the display unit.

21. The computer of claim 20, wherein:
where a command is received to change a size of the mouse cursor, the control unit changes the size of the mouse cursor according to the received command and displays the mouse cursor of the changed size on the display unit.

22. The computer of claim 21, wherein:
where the mouse cursor is away from the predetermined item of the User Interface (UI), the control unit changes the current image shape of the mouse cursor into a prior image shape and displays the prior image shape of the mouse cursor on the display unit.

23. The method of changing the shape of the mouse cursor of claim 3, further comprising:
changing a size of the mouse cursor according to a received command, where the command is received to change the mouse cursor size.

24. The method of changing the shape of the mouse cursor of claim 3, wherein:
where the mouse cursor is away from the predetermined printing option item, the changing the image shape of the mouse cursor comprises changing the current image shape of the mouse cursor into a prior image shape of the mouse cursor.

25. The method of changing the shape of the mouse cursor of claim 3, wherein the changing the image shape of the mouse cursor further comprises:
changing the image shape of the mouse cursor into a prior image shape from the current image shape, where a command is received to remove the current image shape of the mouse cursor.

26. The method of changing the shape of the mouse cursor of claim 4, wherein:
where the mouse cursor is away from the predetermined printing option item, the changing the image shape of the mouse cursor comprises changing the current image shape of the mouse cursor into a prior image shape of the mouse cursor.

27. The method of changing the shape of the mouse cursor of claim 26, wherein the changing the image shape of the mouse cursor further comprises:
changing the image shape of the mouse cursor into a prior image shape from the current image shape, where a command is received to remove the current image shape of the mouse cursor.
